(19) United States
(12) Patent Application Publication
(10) Pub. No.: US 2024/0039664 A1
(43) Pub. Date: Feb. 1, 2024

(54) METHOD AND DEVICE FOR CONSTRUCTING TYPE 1 HARQ-ACK CODEBOOK

(71) Applicant: ZTE CORPORATION, Shenzhen (CN)

(72) Inventors: Wei GOU, Shenzhen (CN); Peng HAO, Shenzhen (CN); Xingguang WEI, Shenzhen (CN); Xing LIU, Shenzhen (CN)

(73) Assignee: ZTE CORPORATION, Shenzhen (CN)

(21) Appl. No.: 18/486,472

(22) Filed: Oct. 13, 2023

Related U.S. Application Data
(63) Continuation of application No. PCT/CN2021/087339, filed on Apr. 15, 2021.

(51) Int. Cl. H04L 1/1829; H04L 12/18

(52) U.S. Cl. CPC H04L 1/1854; H04L 12/1868; H04L 12/189

(57) ABSTRACT

Example implementations include a method of determining, by a wireless communication device, a number of Hybrid Automatic Repeat Request-Acknowledge (HARQ-ACK) bits for each of a plurality of Start and Length Indicator (SLIV) groups, wherein each of the SLIV groups comprises one or more Physical Downlink Shared Channels (PDSCHs) configured for the wireless communication device by a wireless communication node, and sending, by the wireless communication device to the wireless communication node, a signaling that includes a type 1 HARQ-ACK codebook generated based on the determined number of HARQ-ACK bits. Example implementations also include a method of generating, by a wireless communication device, a type 1 Hybrid Automatic Repeat Request-Acknowledge (HARQ-ACK) codebook, and sending, by the wireless communication device to a wireless communication node, the type 1 HARQ-ACK codebook on a Physical Uplink Shared Channel (PUSCH).

### CROSS-REFERENCE TO RELATED APPLICATION

This application claims the benefit of priority under 35 U.S.C. § 120 as a continuation of International Patent Application No. PCT/CN2021/087339, filed on Apr. 15, 2021, the disclosure of which is incorporated herein by reference in its entirety.

### TECHNICAL FIELD

The present implementations relate generally to wireless communications, and more particularly to constructing type 1 HARQ-ACK codebook.

### BACKGROUND

In conventional systems, overheard in wireless communication from various codes can be prohibitively large. Thus, it is advantageous to reduce overheard in wireless communication from various codes.

### SUMMARY

Example implementations include a method of determining, by a wireless communication device, a number of Hybrid Automatic Repeat Request-Acknowledge (HARQ-ACK) bits for each of a plurality of Start and Length Indicator (SLIV) groups, wherein each of the SLIV groups comprises one or more Physical Downlink Shared Channels (PDSCHs) configured for the wireless communication device by a wireless communication node, and sending, by the wireless communication device to the wireless communication node, a signaling that includes a type 1 HARQ-ACK codebook generated based on the determined number of HARQ-ACK bits.

Example implementations also include a method of further determining, by the wireless communication device, that the number of HARQ-ACK bits is equal to a number of PDSCHs contained in each SLIV group.

Example implementations also include a method of further determining, by the wireless communication device, that the number of HARQ-ACK bits is equal to a greater number between a number of PDSCHs contained in each SLIV group and a number of PDSCHs that the wireless communication device is capable of receiving at the same time.

Example implementations also include a method of further determining, by the wireless communication device, that the number of HARQ-ACK bits is equal to a less number between a number of PDSCHs contained in each SLIV group and a number of PDSCHs that the wireless communication device is capable of receiving at the same time.

Example implementations also include a method of further determining, by the wireless communication device, that the number of HARQ-ACK bits is equal to a value configured by the wireless communication node.

Example implementations also include a method of further determining, by the wireless communication device, that the number of HARQ-ACK bits is equal to a number of PDSCHs that the wireless communication device is capable of receiving at the same time.

Example implementations also include a method of further determining, by the wireless communication device, that the number of HARQ-ACK bits is equal to a less number between a number of PDSCHs contained in each SLIV group, a number of frequency division multiplexed PDSCHs that the UE can receive at the same time, and a number of MBS services being received or interested in receiving reported by the UE.

Example implementations also include a method of further determining, by the wireless communication device, that the number of HARQ-ACK bits is equal to a greater number between a number of PDSCHs contained in each SLIV group, a number of frequency division multiplexed PDSCHs that the UE can receive at the same time, and a number of MBS services being received or interested in receiving reported by the UE.

Example implementations also include a method of further determining, by the wireless communication device, that the number of HARQ-ACK bits is equal to a number of MBS services being received or interested in receiving reported by the UE.

Example implementations also include a method of further determining, by the wireless communication device, that the number of HARQ-ACK bits is equal to a less number between a number of frequency division multiplexed PDSCHs that the UE can receive at the same time, and a number of MBS services being received or interested in receiving reported by the wireless communication device.

Example implementations also include a method of further determining, by the wireless communication device, that the number of HARQ-ACK bits is equal to a greater number between a number of frequency division multiplexed PDSCHs that the UE can receive at the same time, and a number of MBS services being received or interested in receiving reported by the UE.

Example implementations also include a method of further, in response to determining that the number of HARQ-ACK bits for one of the SLIV groups is equal to or greater than 2, associating, by the wireless communication device, the HARQ-ACK bits with PDSCHs included in the SLIV group based on respective indices of the PDSCHs in one or more PDSCH Time Domain Resource Allocation (TDRA) tables.

Example implementations also include a method of further in response to determining that a number of the one or more PDSCH TRDA tables is equal to 1, arranging, by the wireless communication device, the HARQ-ACK bits in an ascending or descending order according to the indices of the PDSCHs.

Example implementations also include a method of further, in response to determining that a number of the one or more PDSCH TDRA tables is greater than 1, arranging, by the wireless communication device, the HARQ-ACK bits according to an order of the PDSCH TDRA tables, and arranging, by the wireless communication device, the HARQ-ACK bits in an ascending or descending order according to the indices of the PDSCHs in each of the PDSCH TDRA tables.

Example implementations also include a method of further, in response to determining that the number of HARQ-ACK bits for one of the SLIV groups is equal to or greater than 2, associating, by the wireless communication device, the HARQ-ACK bits with PDSCHs included in the SLIV group based on at least one of: time domain positions of ending symbols of the PDSCHs, time domain positions of starting symbols of the PDSCHs, or frequency domain positions of the PDSCHs.

Example implementations also include a method of further in response to determining that the number of HARQ-ACK bits for one of the SLIV groups is equal to or greater than 2, determining, by the wireless communication device, that PDSCHs included in the SLIV group correspond to Multicast-Broadcast Service (MBS), and associating, by the wireless communication device, the HARQ-ACK bits with the PDSCHs based on respective MBS information of the PDSCHs.

Example implementations also include a method of further determining, by the wireless communication device, that the number of HARQ-ACK bits for one of the SLIV groups is greater than a number of PDSCHs contained in the SLIV group, and generating, by the wireless communication device, each outnumbered HARQ-ACK bit as a Non-acknowledgement (NACK).

Example implementations also include a method of further determining, by the wireless communication device, that the number of HARQ-ACK bits for one of the SLIV groups is greater than a number of PDSCHs that the wireless communication device is capable of receiving at the same time, and generating, by the wireless communication device, each outnumbered HARQ-ACK bit as a Non-acknowledgement (NACK).

Example implementations also include a method of further determining, by the wireless communication device, that the number of HARQ-ACK bits for one of the SLIV groups is less than a number of PDSCHs contained in the SLIV group, and skipping, by the wireless communication device, to generate a HARQ-ACK bit for each outnumbered PDSCHs.

Example implementations also include a method of further determining, by the wireless communication device, that the number of HARQ-ACK bits for one of the SLIV groups is less than a number of PDSCHs that the wireless communication device is capable of receiving at the same time, and skipping, by the wireless communication device, to generate a HARQ-ACK bit for each outnumbered PDSCHs.

Example implementations also include a method of generating, by a wireless communication device, a type 1 Hybrid Automatic Repeat Request-Acknowledge (HARQ-ACK) codebook, and sending, by the wireless communication device to a wireless communication node, the type 1 HARQ-ACK codebook on a Physical Uplink Shared Channel (PUSCH).

Example implementations also include a method of further receiving, by the wireless communication device from the wireless communication node, an uplink grant indicative of generating the type 1 HARQ-ACK codebook based on at least one of: a unicast PDSCH TDRA table, or an MBS PDSCH TDRA table.

Example implementations also include a method of further receiving, by the wireless communication device from the wireless communication node, an uplink grant indicative of generating the type 1 HARQ-ACK codebook based on at least one of: a unicast PDSCH TDRA table, or one or more MBS identifiers.

Example implementations also include a method of receiving, by a wireless communication node from a wireless communication device, a signaling that includes a type 1 Hybrid Automatic Repeat Request-Acknowledge (HARQ-ACK) codebook generated based on a number of HARQ-ACK bits determined for each of a plurality of Start and Length Indicator (SLIV) groups, and configuring, by the wireless communication node for the wireless communication device, one or more Physical Downlink Shared Channels (PDSCHs), where each of the SLIV groups include the one or more PDSCHs.

Example implementations also include a method of receiving, by a wireless communication node from a wireless communication device, a type 1 Hybrid Automatic Repeat Request-Acknowledge (HARQ-ACK) codebook on a Physical Uplink Shared Channel (PUSCH), and sending, by the wireless communication node to the wireless communication device, an uplink grant indicative of generating the type 1 HARQ-ACK codebook based on at least one of a unicast PDSCH TDRA table, or an MBS PDSCH TDRA table, or at least one of a unicast PDSCH TDRA table, or one or more MBS identifiers.

Example implementations also include an apparatus with at least one processor and a memory, wherein the at least one processor is configured to read code from the memory and implement a method according to present implementations.

Example implementations also include a computer program product including a computer-readable program medium code stored thereupon, the code, when executed by at least one processor, causing the at least one processor to implement a method according to present implementations.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates an example cellular communication network in which techniques and other aspects disclosed herein may be implemented, in accordance with an implementation of the present disclosure.

FIG. 2 illustrates block diagrams of an example base station and a user equipment device, in accordance with some implementations of the present disclosure.

FIG. 3 illustrates an example time slot configured with example physical downlink shared channels (PDSCHs), in accordance with present implementations.

FIG. 4 illustrates an example start and length indicator value (SLIV) group associated with a plurality of PDSCHs, in accordance with present implementations.

FIG. 5 illustrates a first example method of constructing a Type 1 HARQ-ACK codebook at a wireless communication device, in accordance with present implementations.

FIG. 6 illustrates an example method of constructing a Type 1 HARQ-ACK codebook at a wireless communication device further to the example method of FIG. 5.

FIG. 7 illustrates an example method of constructing a Type 1 HARQ-ACK codebook at a wireless communication device further to the example method of FIG. 6.

FIG. 8 illustrates a second example method of constructing a Type 1 HARQ-ACK codebook at a wireless communication device, in accordance with present implementations.

FIG. 9A illustrates a third example method of constructing a Type 1 HARQ-ACK codebook at a wireless communication device, in accordance with present implementations.

FIG. 9B illustrates a fourth example method of constructing a Type 1 HARQ-ACK codebook at a wireless communication device, in accordance with present implementations.

FIG. 10 illustrates a first example method of constructing a Type 1 HARQ-ACK codebook at a wireless communication node, in accordance with present implementations.

FIG. 11 illustrates a second example method of constructing a Type 1 HARQ-ACK codebook at a wireless communication node, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

It is to be understood that a Type 1 HARQ-ACK codebook can correspond to a semi-static codebook mechanism. In some implementations, a semi-static codebook mechanism has high reliability and is one of the main HARQ-ACK feedback methods. As one example, a Type 1 HARQ-ACK codebook can be defined in TS38.213.

In some implementations, the type 1 HARQ-ACK codebook is constructed based on RRC signaling, resulting in high reliability. For example, regarding the size of the type 1 HARQ-ACK codebook, the base station and the UE always have a consistent understanding, even if the UE misses the DCI. However, in some implementations, overhead of the type 1 HARQ-ACK codebook is relatively large. It is to be understood that Type 1 HARQ-ACK can be transmitted in PUCCH or PUSCH.

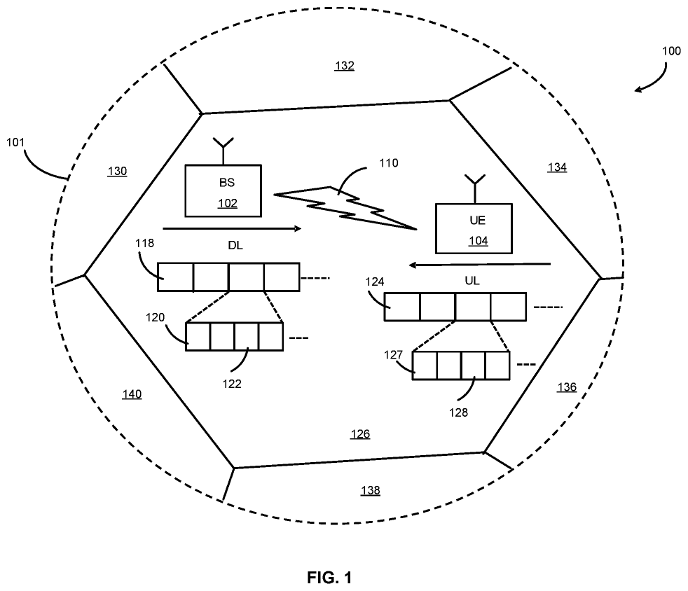

FIG. 1 illustrates an example wireless communication network, and/or system, 100 in which techniques disclosed herein may be implemented, in accordance with an implementation of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

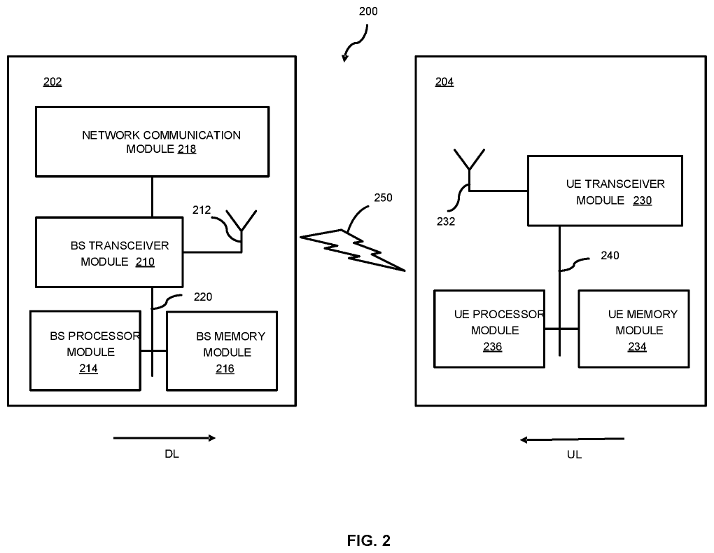

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

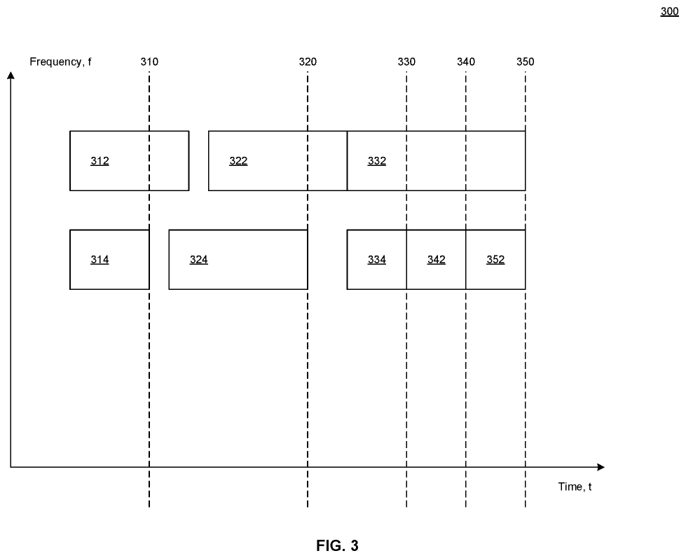

FIG. 3 illustrates an example time slot configured with example physical downlink shared channels (PDSCHs), in accordance with present implementations. As illustrated by way of example in FIG. 3, an example time slot 300 includes a first PDSCH group based on a first earliest PDSCH end position 310 and including a first PDSCH 312 and a second PDSCH 314, a second PDSCH group based on a second earliest PDSCH end position 320 and including a third PDSCH 322 and a fourth PDSCH 324, a third PDSCH group based on a third earliest PDSCH end position 330 and including a fifth PDSCH 332 and a sixth PDSCH 334, a fourth PDSCH group based on a fourth earliest PDSCH end position 340 and including a seventh PDSCH 342, and a fifth PDSCH group based on a fifth earliest PDSCH end position 350 and including an eighth PDSCH 352.

In some implementations, a time slot is configured with eight physical downlink shared channels (PDSCHs). If a Type 1 HARQ-ACK codebook is constructed based on slot, the determination of the existing start and length indicator value (SLIV) group can be one of at least two forms. A first form of determination can include a determination that all PDSCHs configured in the slot are regarded as a PDSCH set. A second form of determination can include finding a PDSCH with the earliest end position from the PDSCH set, and then combining the PDSCH with the earliest end position and the PDSCHs that overlap the PDSCH with the earliest end position in time domain into a SLIV group. Thus, in some implementations, the PDSCHs that have been assigned to the SLIV group are removed from the PDSCH set, and the above process is repeated for the remaining PDSCHs in the PDSCH set until all PDSCHs are processed.

In some implementations, PDSCH resources in a SLIV group are overlapped in the time domain. As one example, the time domain can be or include frequency division multiplexing (FDM). In some implementations, the UE only receives one PDSCH from one SLIV group, that is, the UE cannot receive multiple PDSCHs at the same time. Further, in some implementations, each SLIV group corresponds to a 1-bit HARQ-ACK, and the type 1 HARQ-ACK codebook is constructed according to the sequence of the SLIV group. It is to be understood that one SLIV group can also generate more than 1-bit HARQ-ACK. For example, it can be specified in advance that each SLIV group corresponds to 2-bit HARQ-ACK, or other values.

In some implementations, if the UE has the ability to receive multiple PDSCHs with overlapping time domains at the same time, a particular number of HARQ-ACK bits should be generated for a SLIV group. Further, a particular bit order of these HARQ-ACK bits should be determined. Further, a particular correspondence between these HARQ-ACK bits and PDSCHs in a SLIV group should be determined and applied. In some implementations, PDSCHs may also be PDSCHs of MBS services. For example, PDSCHs of MBS services may be associated with frequency division multiplexing between MBS PDSCH and unicast PDSCH, frequency division multiplexing between multiple MBS PDSCHs, or frequency division multiplexing between multiple unicast PDSCHs. In some implementations, some UEs can only receive one PDSCH from frequency division multiplexed PDSCHs, or from the SLIV group. For example, some UEs can receive 2 PDSCHs from the frequency division multiplexed PDSCHs. For example, some UEs can receive 3 PDSCHs from the frequency division multiplexed PDSCHs.

In some implementations, when the base station side sends MBS PDSCHs, there may be different numbers of MBS service PDSCHs that are frequency division multiplexed. For example, there are 3 MBS service PDSCHs in a SLIV group that are frequency division multiplexed, namely MBS service 1, MBS service 2 and MBS service 3. It is advantageous to generate a type 1 HARQ-ACK codebook where the UE can only receive 2 frequency division multiplexed PDSCHs at the same time. It is further advantageous to generate a particular number of HARQ-ACK bits.

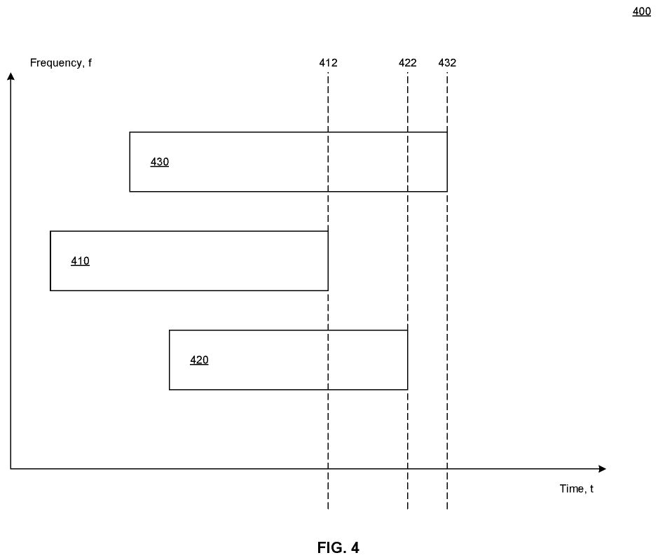

FIG. 4 illustrates an example start and length indicator value (SLIV) group associated with a plurality of PDSCHs, in accordance with present implementations. As illustrated by way of example in FIG. 4, an example SLIV group 400 includes a first PDSCH 410 having a first back position 412, a second PDSCH 420 having a second back position 422, and a third PDSCH 430 having a third back position 432.

In some implementations, a system determines the number of HARQ-ACK bits for a SLIV group for the type 1 HARQ-ACK codebook. For this determination, a number of values including B, K, R and S may be used. B is the number of HARQ-ACK bits corresponding to a SLIV group. K is the number of PDSCHs included in a SLIV group. R is the number of frequency division multiplexed PDSCHs that the UE can receive at the same time. S is the number of MBS services being received or interested in receiving reported by the UE.

In response to constructing a type 1 HARQ-ACK codebook, the number of HARQ-ACK bits corresponding to a SLIV group can be determined according to various operations. As a first example, the number of HARQ-ACK bits corresponding to a SLIV group is always equal to the number of PDSCHs contained in the SLIV group. As a second example, the number of HARQ-ACK bits corresponding to a SLIV group is equal to the greater value between K and R. As a third example, the number of HARQ-ACK bits corresponding to a SLIV group is equal to the lesser value between K and R. As a fourth example, the number of HARQ-ACK bits corresponding to a SLIV group is equal to a value Q configured by the base station. As a fifth example, the number of HARQ-ACK bits corresponding to a SLIV group is always equal to the capability reported by the UE (for example, a value R), which is the number of Frequency division multiplexed PDSCHs that the UE can receive at the same time. As a sixth example, the number of HARQ-ACK bits corresponding to a SLIV group is equal to the lesser value between K, R, and S. As a seventh example, the number of HARQ-ACK bits corresponding to a SLIV group is equal to the greater value between K, R, and S. As an eighth example, the number of HARQ-ACK bits corresponding to a SLIV group is always equal S. As a ninth example, the number of HARQ-ACK bits is equal to a less number between a number of frequency division multiplexed PDSCHs that the UE can receive at the same time, and a number of MBS services being received or interested in receiving reported by the wireless communication device. As a tenth example, the number of HARQ-ACK bits is equal to a greater number between a number of frequency division multiplexed PDSCHs that the UE can receive at the same time, and a number of MBS services being received or interested in receiving reported by the UE. A short summary, by way of example, the number of HARQ-ACK bits is equal to a less (or greater) number between at least two of a number of PDSCHs contained in each SLIV group, a number of PDSCHs that the wireless communication device is capable of receiving at the same time, and a number of MBS services being received or interested in receiving reported by the wireless communication device.

For example, suppose that the value of Q is configured as 2 by the base station, and the value of R is reported as 2 by the UE. Thus, in FIG. 3, according to the first example, the value of B is determined to be 3. According to the second example, the value of B is determined to be 3. According to the third example, the value of B is determined to be 2. According to the fourth example, the value of B is determined to be 2. According to the fifth example, the value of B is determined to be 2.

In some implementations, a system determines the corresponding relationship between HARQ-ACK bits and PDSCHs in a SLIV group. As one example, in response to constructing a type 1 HARQ-ACK codebook, the correspondence between the HARQ-ACK bits corresponding to a SLIV group and the PDSCHs in the SLIV group is determined based on one or more factors. In some implementations, the factors include position of the PDSCH ending symbol, position of the PDSCH starting symbol, and position of the PDSCH in the frequency domain. For example, in a SLIV group, PDSCHs can be ranked, first based on one of the three factors (the first factor), then based on another factor (the second factor), and then based on the remaining factors (the third factor).

As another example, if one of the first to fifth examples above is used, the correspondence between B HARQ-ACK bits corresponding to a SLIV group and PDSCHs in the SLIV group is that B HARQ-ACK bits from left to right correspond to the PDSCHs from front to back according to the position of the PDSCH end symbol. For example, in FIG. 4, a SLIV group contains 3 PDSCHs, namely sorted from front to back according to the position of the PDSCH end symbol 412, 422 and 432. In this way, for the SLIV group, 3 HARQ-ACK bits are generated, and the 3 HARQ-ACK bits are from left to right, corresponding respectively to PDSCH 410, 420 and 430. Further, in the SLIV group, if there are multiple PDSCHs with the same position of the PDSCH end symbol, then the multiple PDSCHs can be further sorted according to the position of the PDSCH in the frequency domain from low to high, or from high to low. Further, if there are multiple PDSCHs with the same position of the PDSCH in the frequency domain, then the multiple PDSCHs can be further sorted according to the position of the PDSCH starting symbol from front to back.

As another example, if one of the first to fifth examples above is used, the correspondence between B HARQ-ACK bits corresponding to a SLIV group and PDSCHs in the SLIV group is that B HARQ-ACK bits from left to right correspond to the PDSCHs from low to high according to the position of the PDSCH in the frequency domain. For example, if FIG. 4, an SLIV group contains 3 PDSCHs sorted from low to high according to the position of the PDSCH in the frequency domain as 420, 410 and 430. In this way, for the SLIV group, 3 HARQ-ACK bits can be generated, and the 3 HARQ-ACK bits can be from left to right, corresponding respectively to PDSCH 420, 410 and 430. Further, in the SLIV group, if there are multiple PDSCHs with the same position of the PDSCH in the frequency domain, then the multiple PDSCHs can be further sorted according to the position of the PDSCH end symbol from front to back. Further, if there are multiple PDSCHs with the same position of the PDSCH end symbol, then the multiple PDSCHs can be further sorted according to the position of the PDSCH starting symbol from front to back.

As another example, if one the first to fifth examples above is used, the correspondence between B HARQ-ACK bits corresponding to a SLIV group and PDSCHs in the SLIV group is that B HARQ-ACK bits from left to right correspond to the PDSCHs from front to back according to the position of the PDSCH starting symbol. For example, in FIG. 4, an SLIV group contains 3 PDSCHs sorted from front to back according to the position of the PDSCH starting symbol as 410, 430 and 420. In this way, for the SLIV group, 3 HARQ-ACK bits can be generated, and the 3 HARQ-ACK bits can be from left to right, corresponding to PDSCH #2, PDSCH #1, and PDSCH #3. Further, in the SLIV group, if there are multiple PDSCHs with the same position of the PDSCH starting symbol, then the multiple PDSCHs can be further sorted according to the position of the PDSCH in the frequency domain from low to high (or from high to low). Further, if there are multiple PDSCHs with the same position of the PDSCH in the frequency domain, then the multiple PDSCHs can be further sorted according to the position of the PDSCH ending symbol from front to back.

As a further example, in response to constructing a Type 1 HARQ-ACK codebook, the correspondence between the HARQ-ACK bits corresponding to a SLIV group and the PDSCHs in the SLIV group can be determined based on PDSCH time domain resource allocation (PDSCH TDRA) index in a PDSCH time domain resource allocation table. For example, B HARQ-ACK bits from left to right correspond to the PDSCHs in ascending (or descending) order according to the PDSCH index. If the PDSCHs in a SLIV group come from different PDSCH TDRA tables, the PDSCHs can be sorted according to the order of PDSCH TDRAs first, and then according to the PDSCH index in PDSCH TDRA. The order of the different PDSCH TDRAs can be determined based on the following operations. In a first operation, the order of different PDSCH TDRA tables is configured by the base station. In a second operation, the order of different PDSCH TDRA tables is pre-arranged by the base station and the UE. For example, the public PDSCH TDRA table is sorted before (or after) the dedicated PDSCH TDRA table. In a third operation, the PDSCH TDRA tables are sorted according to the DCI format. For example, the PDSCH TDRA table corresponding to the DCI1-1 format is before (or after) the PDSCH TDRA table corresponding to the DCI1-2 format. As another example, there are two PDSCH TDRA tables, denoted as Table A and Table B. In this example, 4 PDSCH TDRAs in Table A, and their indexes are 0-3; in Table B, there are 2 PDSCH TDRAs, and their indexes are 0-1. A SLIV can contain 3 PDSCH TDRAs, including PDSCH TDRA1 and PDSCH TDRA3 in Table A, and PDSCH TDRA0 in Table B. Here, the BS and the UE agree that the Table A is arranged in front of the Table B, and in ascending order according to the index of the PDSCH TDRA. Thus, a sequence of the PDSCH TDRA corresponding to the HARQ-ACK bit sequence generated for this SLIV group can be PDSCH TDRA1 in Table A, PDSCH TDRA3 in Table B, and PDSCH TDRA0 in Table B.

In some implementations, the PDSCHs can be MBS PDSCHs in whole or in part. For example, if the MBS PDSCHs of multiple MBS services received by the UE at the same time are from one SLIV group, then, in addition to the above methods, the following methods can also be used: the correspondence between B HARQ-ACK bits and the PDSCHs in the SLIV group can also be determined based on the following method.

In response to constructing a type 1 HARQ-ACK codebook, the correspondence between the HARQ-ACK bits corresponding to a SLIV group and the MBS PDSCHs in the SLIV group can be determined based on the order of MBS service information corresponding to the MBS PDSCH in UE reporting signaling. For example, B HARQ-ACK bits from left to right can correspond to the MBS PDSCHs according to the MBS service information of the each PDSCH from front to back (or from back to front) in the UE reporting signaling. The reporting signaling can be the signaling that the UE reports that it is interested in the MBS service or is receiving the MBS service. Thus, in this example, reporting signaling is designed for the UE. The UE can set the sequence of interested (receiving) MBS service information in the reporting signaling, and the UE can use the sequence to determine the sequence of HARQ-ACKs corresponding to MBS PDSCHs of different MBS services in a SLIV group. It can also be considered that when the UE reports the MBS service information that it is receiving or is interested in to the base station, the order of the MBS service information can be determined in the reporting signaling to determine the order of the MBS service to be received by the UE. In some implementations, if the UE has limited capabilities, only the MBS services with the top MBS service information will be received.

For example, the number of Frequency division multiplexed PDSCH received by the UE at the same time is 2, and the order of the MBS service information of the MBS service being received by the UE in the reporting signaling is: MBS service 2, MBS service 3 and MBS service 1, then, if these three MBS services are frequency division multiplexed, the UE will receive MBS service 2 and MBS service 3, but not MBS service 1, because the UE is capable of receiving two frequency division multiplexed PDSCHs at the same time.

It is to be understood that if multiple MBS services are frequency division multiplexed, the base station can inform the UE which MBS services to receive, and the order of the MBS services in the notification signaling can also be the order in which the MBS services are received and the order of HARQ-ACKs for MBS PDSCHs in a SLIV group. For example, the MBS PDSCHs of 3 MBS services are frequency division multiplexed, but the UE capability is to receive 2 PDSCHs at the same time. In this case, the base station notifies the UE which MBS services are received, that is, it notifies the UE which MBS PDSCHs are received.

For example, the base station notifies the UE that MBS service 2 and MBS service 3 (MBS service 2 is before MBS service 3 in the signaling) are received, so that the UE does not receive MBS service 1. In response to generating a type 1 HARQ-ACK codebook, for a SLIV group, if it contains MBS service 1, MBS service 2 and MBS service 3 corresponding to MBS PDSCHs, then the UE generates HARQ-ACKs for MBS service 2 and MBS service 3, and the HARQ-ACK of MBS service 2 is before the HARQ-ACK of MBS service 3, and the HARQ-ACK is not generated as MBS service 1.

Regarding special case handling. For an SLIV group, if the value of B is not equal to the value of K, that is, some HARQ-ACK bits do not have corresponding PDSCHs, or some PDSCHs do not have corresponding HARQ-ACKs, operation can be in accordance with the following.

First, if a HARQ-ACK information does not have a corresponding PDSCH, then the HARQ-ACK information can be set to NACK. For example, if B is greater than K, the last (B-K) bits in B bits are set to NACK due to lack of corresponding PDSCHs. For example, the UE can determine that 4 HARQ-ACK bits are generated as a SLIV group through one of the methods in the first to fifth examples above, but there are only 3 PDSCHs in the SLIV group, as shown in FIG. 3. Here, UE uses B HARQ-ACK bits from left to right correspond to the PDSCHs from front to back according to the position of the PDSCH end symbol to determine the correspondence between the 4 HARQ-ACK bits and PDSCHs in a SLIV group. Then, the first 3 HARQ-ACK bits in the 4 HARQ-ACK bits correspond to 410, 420 and 430, respectively. The 4th HARQ-ACK information is set to NACK because the 4th HARQ-ACK bit does not have a corresponding PDSCH.

Second, if a PDSCH does not have a corresponding HARQ-ACK information, then the HARQ-ACK information can be not generated for the PDSCH. For example, if B is less than K, the last (K-B) PDSCHs in PDSCHs in the SLIV group will not generate HARQ-ACK information due to lack of corresponding HARQ-ACK. In this example, the UE uses B HARQ-ACK bits from left to right corresponding to the PDSCHs from front to back according to the position of the PDSCH end symbol to sort the PDSCHs in a SLIV group. For example, suppose that the UE determines that 2 HARQ-ACK bits are generated as a SLIV group by one of the first to fifth examples above, but there are 3 PDSCHs in the SLIV group as shown in FIG. 4. In this example, the UE uses B HARQ-ACK bits from left to right correspond to the PDSCHs from front to back according to the position of the PDSCH end symbol to determine the correspondence between the 2 HARQ-ACK bits and PDSCHs in a SLIV group. Then, the 2 HARQ-ACK bits can correspond to 410 and 420 respectively. No HARQ-ACK information is generated for the 430 due to lack of corresponding HARQ-ACK information.

It is advantageous to reduce the overhead of the type 1 HARQ-ACK codebook if the type 1 HARQ-ACK codebook is transmitted on the PUSCH. In some implementations, if a type 1 HARQ-ACK codebook is configured and the UE receives MBS services and unicast services, the UE can generate a Type 1 HARQ-ACK codebook for the two services and transmits the Type 1 HARQ-ACK codebook on a PUSCH scheduled by DCI. In some implementations, the PUSCH is schedule by UL grant.

In this case, the base station sets an indication information 1 in the UL grant. The indication information 1 can be used to inform the UE that the type 1 HARQ-ACK codebook is generated based on one of the following: a union of unicast PDSCH TDRA table and MBS PDSCH TDRA table; only unicast PDSCH TDRA table; only MBS PDSCH TDRA table; only unicast PDSCH TDRA, only multicast PDSCH TDRA, and the union of PDSCH TDRA uses unicast and multicast PDSCH TDRA respectively, only the unicast k1 set is used, only the multicast k1 set is used, and the union of the k1 sets uses the unicast and multicast k1 sets respectively. In some implementations, k1 indicates that an interval is between the slot where a PDSCH is located and the slot where the HARQ-ACK corresponding to the PDSCH is located.

Further, in some implementations, the base station can set indication information 2 in the UL grant. The indication information 2 can be used to inform the UE that the type 1 HARQ-ACK codebook is generated based on one of the following: only one or more MBS service identifiers; only unicast PDSCH TDRA; a union of one or more MBS service identifiers and the unicast PDSCH TDRA. Here, the one or more MBS service identifiers means that the UE uses the PDSCH TDRA of the MBS service corresponding to the one or more MBS service identifiers.

Further, in some implementations, in response to the unicast PDSCH TDRA being used as a type 1 HARQ-ACK codebook, operations can also include using the k1 set corresponding to the DCI format configured for the UE in the unicast, not including the k1 set corresponding to the multicast. For example, if the UE is configured with DCI1-1 in unicast, the generation of the Type 1 HARQ-ACK codebook can be based on the k1 set corresponding to DCI1-1. If in unicast, the UE can be configured with DCI1-1 and DCI1-2, the generation of the type 1 HARQ-ACK codebook also can be based on the union of the k1 sets corresponding to DCI1-1 and DCI1-2 respectively.

Further, in some implementations, if the multicast PDSCH TDRA is used to construct a type 1 HARQ-ACK codebook, operations can also include a k1 set corresponding to the DCI format configured for the UE in the multicast. For example, if the UE is configured with DCI1-3 in multicast, the generation of the type 1 HARQ-ACK codebook also can be based on the k1 set corresponding to DCI1-3. If in multicast, the UE is configured with DCI1-3 and DCI1-4, then the generation of the type 1 HARQ-ACK codebook also can be based on the union of the k1 sets corresponding to DCI1-3 and DCI1-4 respectively.

Further, in some implementations, the aforementioned unicast/multicast PDSCH TDRA specifically includes determining the corresponding PDSCH TDRA according to the configured DCI format of the scheduled PDSCH. In some implementations, the DCI format includes DCI1-0, DCI1-1, and DCI1-2, where more DCI formats can be included. For example, if the UE is configured with DCI1-1, then the PDSCH TDRA is the PDSCH TDRA corresponding to DCI1-1, not including other PDSCH TDRA. If the UE is configured with DCI1-1 and DCI1-2, then the PDSCH TDRA can be a union of PDSCH TDRA corresponding to DCI1-1 and DCI1-2 respectively.

It is to be understood that the overhead of the type 1 HARQ-ACK codebook can be reduced. For example, in general, an MBS service is periodically scheduled for transmission. In this period, if the UE only has unicast services to be received, the UE only needs to generate a type 1 HARQ-ACK codebook for unicast services, thereby reducing overhead. As one example, only the unicast PDSCH TDRA is used, and the k1 set corresponding to the unicast DCI format is used. Similarly, the base station can skip scheduling unicast services for a period of time. Thus, in some implementations, the UE is only scheduled for MBS services during this period. the UE only needs to generate a type 1 HARQ-ACK codebook for MBS services, thereby reducing overhead. As one example, only the MBS PDSCH TDRA is used, and the k1 set corresponding to the MBS DCI format is used. In this period, if the UE has unicast and MBS services to be received, the UE can a Type 1 HARQ-ACK codebook for unicast and MBS services. For example, the unicast and MBS PDSCH TDRA can be used, and a union of the k1 set corresponding to unicast DCI format and MBS DCI format respectively.

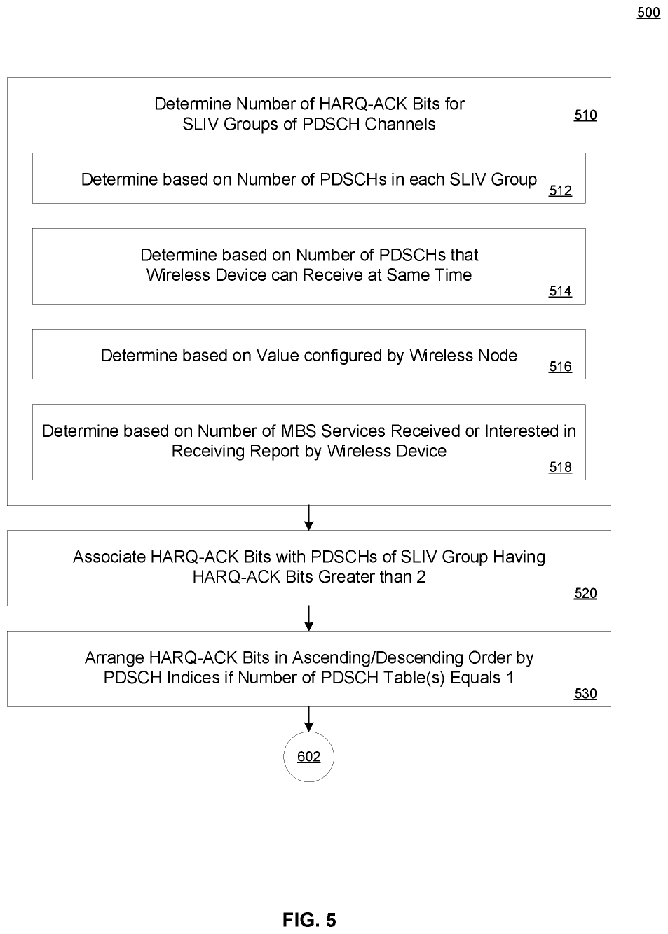

FIG. 5 illustrates a first example method of constructing a Type 1 HARQ-ACK codebook at a wireless communication device, in accordance with present implementations. In some implementations, at least the UE 104 performs method 500 according to present implementations. It is to be understood that that one or more steps or substeps of method 500 can be omitted or rearranged in accordance with present implementations. In some implementations, the method 500 begins at step 510.

At step 510, the example system determines a number of HARQ-ACK bits for one or more SLIV groups of PDSCH channels. In some implementations, step 510 includes at least one of steps 512, 514, 516 and 518. At step 512, the example system determines a number of HARQ-ACK bits for one or more SLIV groups of PDSCH channels based on a number of PDSCHs in each SLIV group. At step 514, the example system determines a number of HARQ-ACK bits for one or more SLIV groups of PDSCH channels based on a number of PDSCHs that a wireless communication device can receive at the same time. At step 516, the example system determines a number of HARQ-ACK bits for one or more SLIV groups of PDSCH channels based on a value configured by a wireless communication node. At step 518, the example system determines a number of HARQ-ACK bits for one or more SLIV groups of PDSCH channels based on a number of MBS services received of interested in receiving a report by a wireless communication device. It is to be understood that the example system can determine a number of HARQ-ACK bits for one or more SLIV groups of PDSCH channels based on one or more of 512, 514, 516 and 518. It is to be further understood that that the example system can determine a number of HARQ-ACK bits for one or more SLIV groups of PDSCH channels based on one or more of determining equality, greater than, less than, or the like. The method 500 then continues to step 520.

At step 520, the example system associates HARQ-ACK bits with PDSCHs of an SLIV group having HARQ-ACK bits greater than 2. The method 500 then continues to step 530. At step 530, the example system arranges HARQ-ACK bits in ascending or descending order by PDSCH indices if a number of PDSCH tables equals 1. The method 500 then continues to step 602.

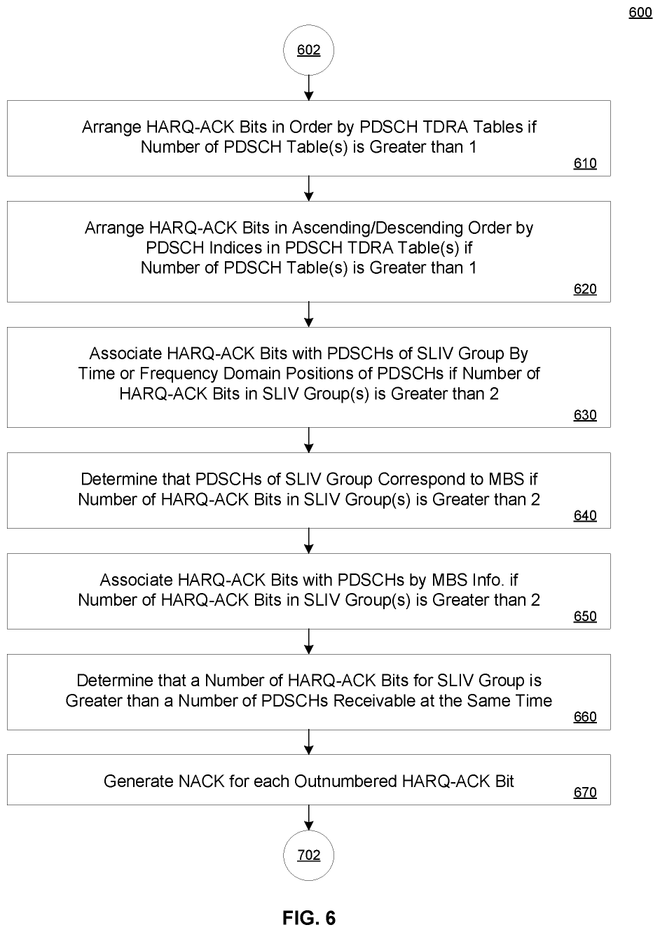

FIG. 6 illustrates an example method of constructing a Type 1 HARQ-ACK codebook at a wireless communication device further to the example method of FIG. 5. In some implementations, at least the UE 104 performs method 600 according to present implementations. It is to be understood that that one or more steps or substeps of method 600 can be omitted or rearranged in accordance with present implementations. In some implementations, the method 600 begins at step 602. The method 600 then continues to step 610.

At step 610, the example system arranges HARQ-ACK bits in order by PDSCH TDRA tables if a number of PDSCH tables is greater than 1. The method 600 then continues to step 620.

At step 620, the example system arranges HARQ-ACK bits in ascending or descending order by PDSCH indices in PDSCH TDRA tables if a number of PDSCH tables is greater than 1. The method 600 then continues to step 630.

At step 630, the example system associates HARQ-ACK bits with PDSCHs of an SLIV group by at least one of time domain positions of PDSCHs and frequency domain positions of PDSCHs, if a number of HARQ-ACK bits in one or more SLIV groups is greater than 2. The method 600 then continues to step 640.

At step 640, the example system determines that PDSCHs of at least one SLIV group correspond to MBS if a number of HARQ-ACK bits in the SLIV group is greater than 2. The method 600 then continues to step 650.

At step 650, the example system associates HARQ-ACK bits with PDSCHs by MBS information, if a number of HARQ-ACK bits in SLIV groups is greater than 2. The method 600 then continues to step 660.

At step 660, the example system determines that a number of HARQ-ACK bits for an SLIV group is greater than a number of PDSCHs receivable at the same time. The method 600 then continues to step 670.

At step 670, the example system generates a NACK for each outnumbered HARQ-ACK bit. The method 600 then continues to step 702.

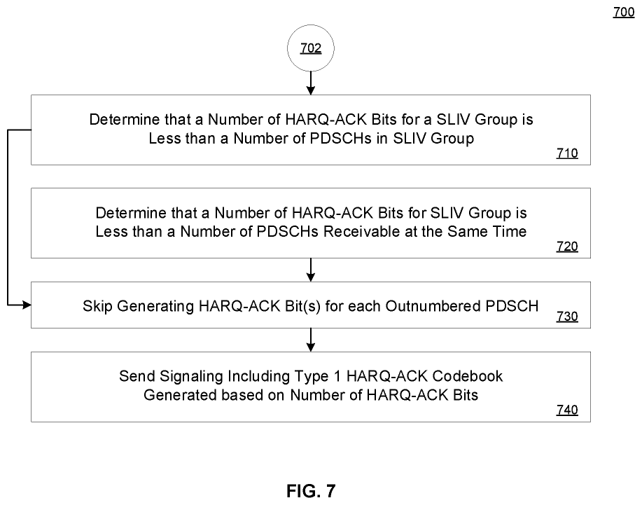

FIG. 7 illustrates an example method of constructing a Type 1 HARQ-ACK codebook at a wireless communication device further to the example method of FIG. 6. In some implementations, at least the UE 104 performs method 700 according to present implementations. It is to be understood that that one or more steps or substeps of method 700 can be omitted or rearranged in accordance with present implementations. In some implementations, the method 700 begins at step 702. The method 700 then continues to step 710.

At step 710, the example system determines that a number of HARQ-ACK bits for at least one SLIV group is less than a number of PDSCHs in the SLIV group. The method 700 then continues to step 720. At step 720, the example system determines that a number of HARQ-ACK bits for at least one SLIV group is less than a number of PDSCHs receivable at the same time. The method 700 then continues to step 730. At step 730, the example system skips generating HARQ-ACK bits for each outnumbered PDSCH. The method 700 then continues to step 740. At step 740, the example system sends signaling including Type 1 HARQ-ACK codebook generated based on a number of HARQ-ACK bits. In some implementations, the method 700 ends at step 740.

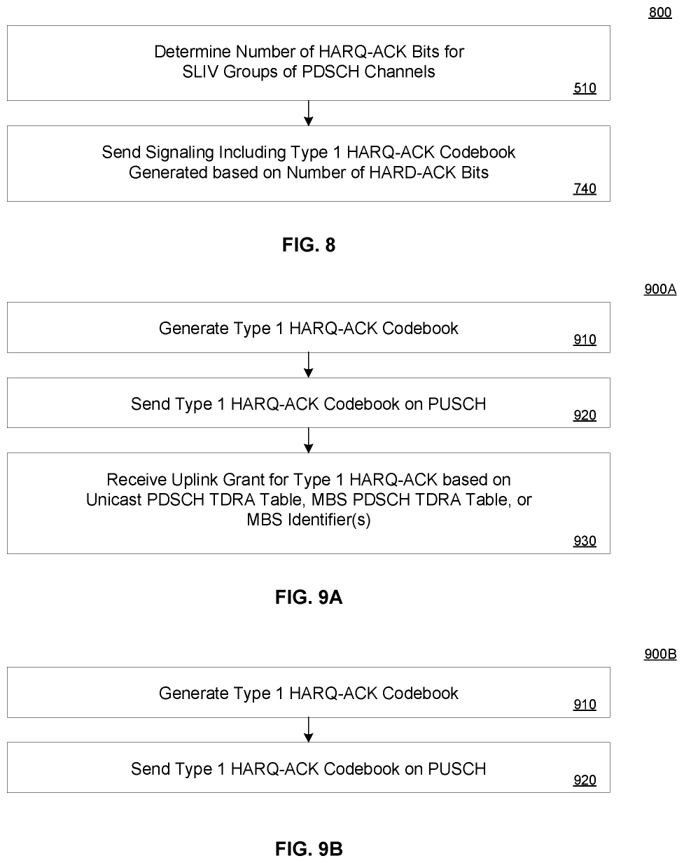

FIG. 8 illustrates a second example method of constructing a Type 1 HARQ-ACK codebook at a wireless communication device, in accordance with present implementations. In some implementations, at least the UE 104 performs method 800 according to present implementations. In some implementations, the method 800 begins at step 510. At step 510, the example system determines a number of HARQ-ACK bits for one or more SLIV groups of PDSCH channels. The method 800 then continues to step 740. At step 740, the example system sends signaling including Type 1 HARQ-ACK codebook generated based on a number of HARQ-ACK bits. In some implementations, the method 800 ends at step 740.

FIG. 9A illustrates a third example method of constructing a Type 1 HARQ-ACK codebook at a wireless communication device, in accordance with present implementations. In some implementations, at least the UE 104 performs method 900A according to present implementations. In some implementations, the method 900A begins at step 910. At step 910, the example system generates Type 1 HARQ-ACK codebook. The method 900A then continues to step 920. At step 920, the example system sends Type 1 HARQ-ACK codebook on PUSCH. The method 900A then continues to step 930. At step 930, the example system receives an uplink grant for Type 1 HARQ-ACK based on at least one of a unicast PDSCH TDRA table, an MBS PDSCH TDRA table, and one or more MBS identifiers. In some implementations, the method 900A ends at step 930.

FIG. 9B illustrates a fourth example method of constructing a Type 1 HARQ-ACK codebook at a wireless communication device, in accordance with present implementations. In some implementations, at least the UE 104 performs method 900B according to present implementations. In some implementations, the method 900B begins at step 910. At step 910, the example system Type 1 HARQ-ACK codebook. The method 900B then continues to step 920. At step 920, the example system sends Type 1 HARQ-ACK codebook on PUSCH. In some implementations, the method 900B ends at step 920.

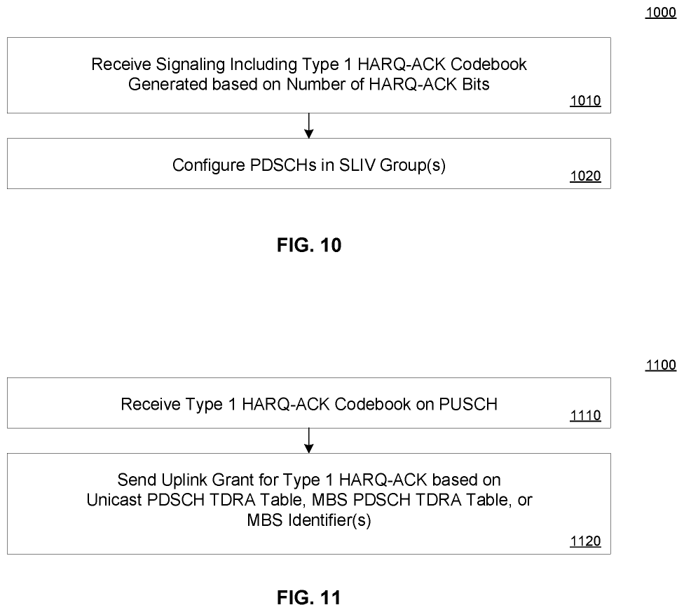

FIG. 10 illustrates a first example method of constructing a Type 1 HARQ-ACK codebook at a wireless communication node, in accordance with present implementations. In some implementations, at least one of the BS 102 performs method 1000 according to present implementations. In some implementations, the method 1000 begins at step 1010. At step 1010, the example system receives signaling including Type 1 HARQ-ACK codebook generated based on a number of HARQ-ACK bits. The method 1000 then continues to step 1020. At step 1020, the example system configures one or more PDSCHs in one or more corresponding SLIV groups. In some implementations, the method 1000 ends at step 1020.

FIG. 11 illustrates a second example method of constructing a Type 1 HARQ-ACK codebook at a wireless communication node, in accordance with present implementations. In some implementations, at least one of the BS 102 performs method 1100 according to present implementations. In some implementations, the method 1100 begins at step 1110. At step 1110, the example system receives Type 1 HARQ-ACK codebook on PUSCH. The method 1100 then continues to step 1120. At step 1120, the example system sends an uplink grant for Type 1 HARQ-ACK based on at least one of a unicast PDSCH TDRA table, an MBS PDSCH TDRA table, and one or more MBS identifiers. In some implementations, the method 1100 ends at step 1120.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent. The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A wireless communication method, comprising:
generating, by a wireless communication device, a type 1 Hybrid Automatic Repeat Request-Acknowledge (HARQ-ACK) codebook; and
sending, by the wireless communication device to a wireless communication node, the type 1 HARQ-ACK codebook on a Physical Uplink Shared Channel (PUSCH) which is scheduled by an uplink grant.

2. The wireless communication method of claim 1, further comprising:
generating, by the wireless communication device, the type 1 HARQ-ACK codebook based on indication information in the uplink grant and the received service,
wherein the type 1 HARQ-ACK codebook is generated based on the indication information, and generated using at least one of: a union of unicast PDSCH TDRA table and MBS PDSCH TDRA table, a unicast PDSCH TDRA table, an MBS PDSCH TDRA table, a union of unicast PDSCH TDRA and multicast PDSCH TDRA, a unicast PDSCH TDRA, or a multicast PDSCH TDRA.

3. The wireless communication method of claim 1, comprising:
generating, by the wireless communication device, the type 1 HARQ-ACK codebook for unicast service, if a unicast service is received by the wireless communication device.

4. The wireless communication method of claim 3, comprising:
generating, by the wireless communication device, the type 1 HARQ-ACK codebook for unicast service using a unicast PDSCH TDRA or a unicast PDSCH TDRA table, if a unicast service is received by the wireless communication device.

5. The wireless communication method of claim 1, comprising:
generating, by the wireless communication device, the type 1 HARQ-ACK codebook for MBS service, if an MBS service is received by the wireless communication device.

6. The wireless communication method of claim 5, comprising:
generating, by the wireless communication device, the type 1 HARQ-ACK codebook for MBS service using an MBS PDSCH TDRA or an MBS PDSCH TDRA table, if an MBS service is received by the wireless communication device.

7. The wireless communication method of claim 1, comprising:
generating, by the wireless communication device, the type 1 HARQ-ACK codebook for MBS service and unicast service, if a unicast service and an MBS service are received by the wireless communication device.

8. The wireless communication method of claim 7, comprising:
generating, by the wireless communication device, the type 1 HARQ-ACK codebook for MBS service and unicast service using a unicast PDSCH TDRA and an MBS PDSCH TDRA, or using a unicast PDSCH TDRA table and an MBS PDSCH TDRA table, or using a union of unicast PDSCH TDRA table and MBS PDSCH TDRA table, if a unicast service and an MBS service are received by the wireless communication device.

9. The wireless communication method of claim 1, further comprising:
receiving, by the wireless communication device from the wireless communication node, the uplink grant indicative of generating the type 1 HARQ-ACK codebook based on at least one of: a unicast PDSCH TDRA table, or one or more MBS identifiers.

10. A wireless communication method, comprising:
receiving, by a wireless communication node from a wireless communication device, a type 1 Hybrid Automatic Repeat Request-Acknowledge (HARQ-ACK) codebook on a Physical Uplink Shared Channel (PUSCH) which is scheduled by an uplink grant; and
sending, by the wireless communication node to the wireless communication device, the uplink grant and a service,
wherein the type 1 HARQ-ACK codebook is generated based on indication information in the uplink grant and the received service, and generated using
at least one of: a union of unicast PDSCH TDRA table and MBS PDSCH TDRA table, a unicast PDSCH TDRA table, an MBS PDSCH TDRA table, the union of unicast PDSCH TDRA and multicast PDSCH TDRA, a unicast PDSCH TDRA, or a multicast PDSCH TDRA.

11. The wireless communication method of claim 10, wherein the wireless communication device generates the type 1 HARQ-ACK codebook for unicast service, if a unicast service is received by the wireless communication device.

12. The wireless communication method of claim 11, wherein the wireless communication device generates the type 1 HARQ-ACK codebook for unicast service using the unicast PDSCH TDRA or a unicast PDSCH TDRA table, if a unicast service is received by the wireless communication device.

13. The wireless communication method of claim 10, wherein the wireless communication device generates the type 1 HARQ-ACK codebook for MBS service, if an MBS service is received by the wireless communication device.

14. The wireless communication method of claim 13, wherein the wireless communication device generates the type 1 HARQ-ACK codebook for MBS service using the MBS PDSCH TDRA or an MBS PDSCH TDRA table, if an MBS service is received by the wireless communication device.

15. The wireless communication method of claim 10, wherein the wireless communication device generates the type 1 HARQ-ACK codebook for MBS service and unicast service, if a unicast service and an MBS service are received by the wireless communication device.

16. The wireless communication method of claim 15, wherein the wireless communication device generates the type 1 HARQ-ACK codebook for MBS service and unicast service using the unicast PDSCH TDRA and the MBS PDSCH TDRA or using a unicast PDSCH TDRA table and an MBS PDSCH TDRA table or using a union of unicast PDSCH TDRA table and MBS PDSCH TDRA table, if a unicast service and an MBS service are received by the wireless communication device.

17. A wireless communication device, comprising:
at least one processor configured to:
generate a type 1 Hybrid Automatic Repeat Request-Acknowledge (HARQ-ACK) codebook; and
send, via a transmitter to a wireless communication node, the type 1 HARQ-ACK codebook on a Physical Uplink Shared Channel (PUSCH) which is scheduled by an uplink grant.

18. A wireless communication node, comprising:
at least one processor configured to:
receive, via a transceiver from a wireless communication device, a type 1 Hybrid Automatic Repeat Request-Acknowledge (HARQ-ACK) codebook on a Physical Uplink Shared Channel (PUSCH) which is scheduled by an uplink grant; and
send, via the transceiver to the wireless communication device, the uplink grant and a service,
wherein the type 1 HARQ-ACK codebook is generated based on indication information in the uplink grant and the received service, and generated using at least one of: a union of unicast PDSCH TDRA table and MBS PDSCH TDRA table, a unicast PDSCH TDRA table, an MBS PDSCH TDRA table, the union of unicast PDSCH TDRA and multicast PDSCH TDRA, a unicast PDSCH TDRA, or a multicast PDSCH TDRA.
